(19) United States
(12) Patent Application Publication
(10) Pub. No.: US 2005/0219977 A1
(43) Pub. Date: Oct. 6, 2005

(54) Digital recording/reproducing apparatus and rotating speed control method thereof

(75) Inventor: Ching-Hai Chen, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On it Corp.

(21) Appl. No.: 11/094,012

(22) Filed: Mar. 30, 2005

(30) Foreign Application Priority Data
Apr. 5, 2004 (TW) 093109377

(51) Int. Cl. G11B 5/09

(52) U.S. Cl. 369/47.38; 369/84

(57) ABSTRACT

A digital recording/reproducing apparatus, such as a DVD recorder, is capable of copying data between a non-volatile memory thereof and a disc at different rotating speeds. By asserting a speed-up signal to the control circuit for controlling the disc burner of the digital recording/reproducing apparatus via a command input device, the rotating speed of the disc burner can be accelerated so as to speed up the recordation of data. For example, a hot key on the control panel or remote controller can be triggered to assert the speed-up signal.

### FIELD OF THE INVENTION

The present invention relates to a digital recording/reproducing apparatus such as a DVD recorder and a rotating speed control method of a digital recording/reproducing apparatus, and more particularly to a digital recording/reproducing apparatus with selectable rotating speeds.

### BACKGROUND OF THE INVENTION

Referring to FIG. 1, a functional block diagram of a typical digital recording/reproducing apparatus is shown. A digital recording/reproducing apparatus, for example a DVD recorder 10, is used to record video data into a recordable disc or reproduce video data from a readable disc. Nowadays, the digital recording/reproducing apparatus 10 can be used with various kinds of electrical appliances to record video data from various sources. For example, the analog video signals received from the TV tuner 11 are transmitted to the control circuit 16 to be converted into digital data in a specified format such as MPEG. The digital data in the MPEG format are then recorded into a recordable disc 15 loaded in the disc burner 17 of the DVD recorder 10. Likewise, the analog video signals received from the video cassette recorder (VCR) 12 or the DVD player 13 or the digital video signals received from the digital video (DV) camera 14 can also be converted into digital data in a specified format such as MPEG by the control circuit 16 to be recorded into the recordable disc 15.

Referring to FIG. 2, a functional block diagram of another digital recording/reproducing apparatus is shown. The digital recording/reproducing apparatus 100 comprises a disc burner 102, a control circuit 106 and a digital data storage device such as a hard disc 101. The signals received from the TV tuner 11, the VCR 12, the DVD player 13 or the DV camera 14 are firstly converted into digital data in a specified format such as MPEG by the control circuit 106. The MPEG digital data are then stored in the hard disc 101 in an editable manner. The edited digital data is then recorded into the recordable disc 15 by the disc burner 102. On the other hand, it is also possible to record the data previously stored in the disc 15 into the hard disc 101.

As known, noise control is an important issue for home appliance design. In general, lower operation speed of an electrical appliance would result in less noise. Since a DVD recorder is used for playing more frequently than recording, the disc burner is normally set at a low rotating speed that is enough for the playing operation in order to minimize noise. In other words, in either of the above recording cases, i.e. no matter whether recordation is made directly from the signal source or via the hard disc, the recordation is executed under the fixed low rotating speed of the disc burner. Such setting is, apparently, inflexible and inefficient.

### SUMMARY OF THE INVENTION

Therefore, the present invention provides a digital recording/reproducing apparatus with selectable rotating speeds. With proper selection, the rotating speed of the disc burner can be accelerated in certain situation, for example when no noise issue would be raised, so as to improve flexibility and efficiency.

The present invention provides an operational speed control method of a digital recording/reproducing apparatus. The digital recording/reproducing apparatus has a non-volatile memory, a disc burner and a command input device. The method comprises steps of asserting a state-switching signal in response to a triggering operation of the command input device; and changing an operational speed of the disc burner for copying data between the non-volatile memory and a disc in response to the state-switching signal.

In an embodiment, the triggering operation of the command input device is implemented by pushing a hot key on the command input device.

In an embodiment, the operational speed of the disc burner is changed between a high rotating speed and a low rotating speed in response to the state-switching signal.

In an embodiment, the state-switching signal is transmitted from the command input device to a control circuit for controlling the disc burner via a cable.

Alternatively, the state-switching signal is transmitted wirelessly from the command input device to a control circuit for controlling the disc burner.

The disc should be a recordable disc if the data is previously stored in the non-volatile memory and is to be written into the disc.

The operational speed control method preferably further comprises a step of presetting an initial operational speed of the disc burner at a first rotating speed, and the first rotating speed will be increased to a second rotating speed in response to the triggering operation of the command input device.

The present invention further provides a rotating speed control method of a digital recording/reproducing apparatus comprising steps of asserting a speed-up signal in response to a triggering operation of a command input device; and accelerating a rotating speed of a disc burner for copying data between a non-volatile memory and a disc from a first rotating speed to a second rotating speed in response to the speed-up signal.

The present invention further provides a digital recording/reproducing apparatus, which comprises a control circuit; a non-volatile memory; a disc burner electrically connected to the control circuit and selectively operated at a first rotating speed or a second rotating speed under the control of the control circuit for copying data between the non-volatile memory and a disc at different operational speeds; and a command input device coupled to the control circuit and changing an operational speed of the disc burner between the first and second rotating speeds in response to a user' operation.

In an embodiment, the command input device includes a hot key and the user's operation is the actuation of the hot key.

In an embodiment, the command input device is a control panel electrically connected to the control circuit via a cable.

In an embodiment, the command input device is a remote controller in wireless communication with the control circuit.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a conventional digital recording/reproducing apparatus with a plurality of external data sources;

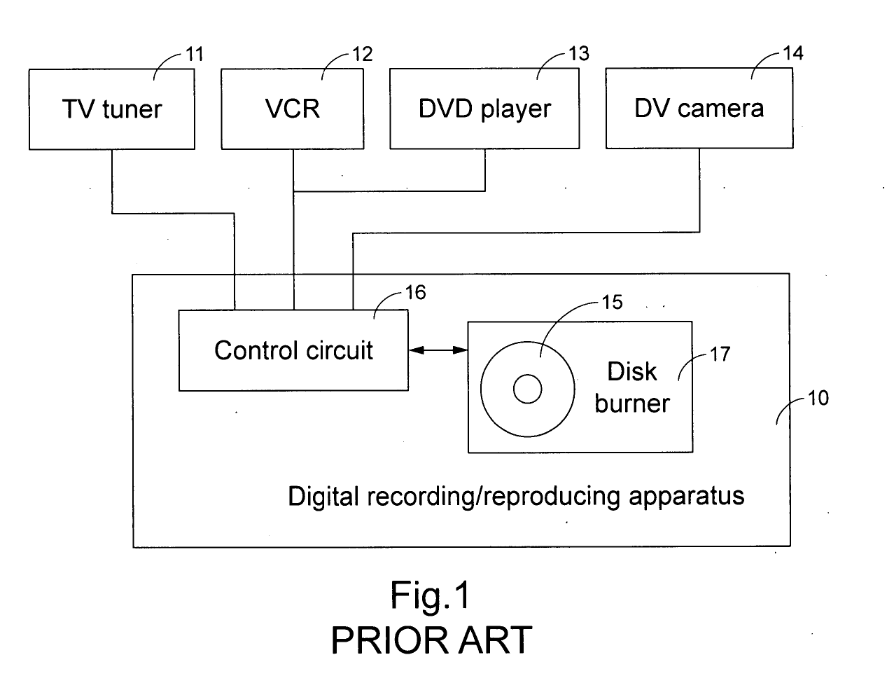

FIG. 2 is a schematic functional block diagram illustrating another conventional digital recording/reproducing apparatus with a plurality of external data sources;

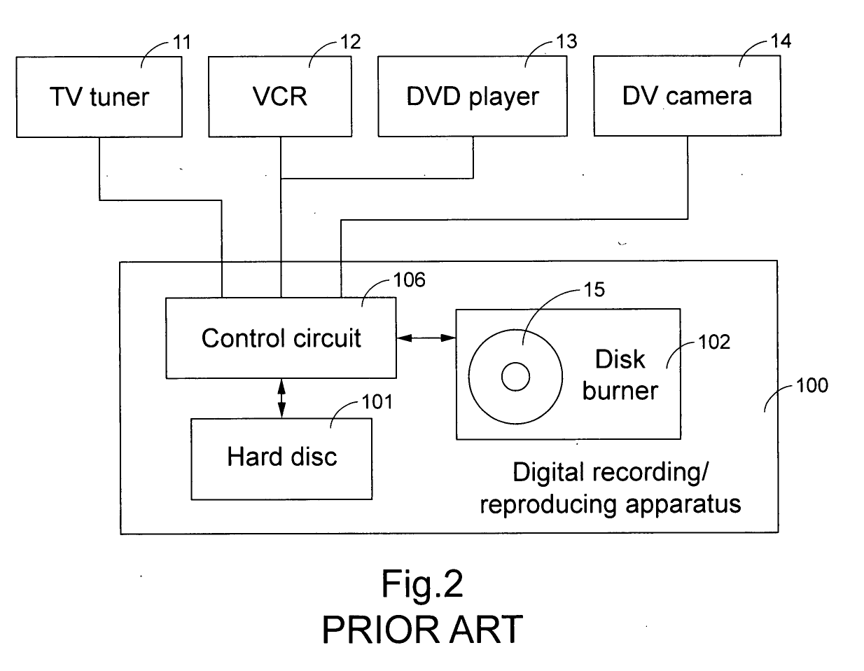

FIG. 3 is a schematic functional block diagram illustrating an embodiment of a digital recording/reproducing apparatus according to the present invention;

FIG. 4A is a flowchart illustrating a rotating speed control method of the digital recording/reproducing apparatus of FIG. 3;

FIG. 4B is a flowchart illustrating another rotating speed control method of the digital recording/reproducing apparatus of FIG. 3; and

FIG. 5 is a schematic functional block diagram illustrating an embodiment of a digital recording/reproducing apparatus according to the present invention.

### DETAILED DESCRIPTION OF THE PREFERRED EMBODIMENT

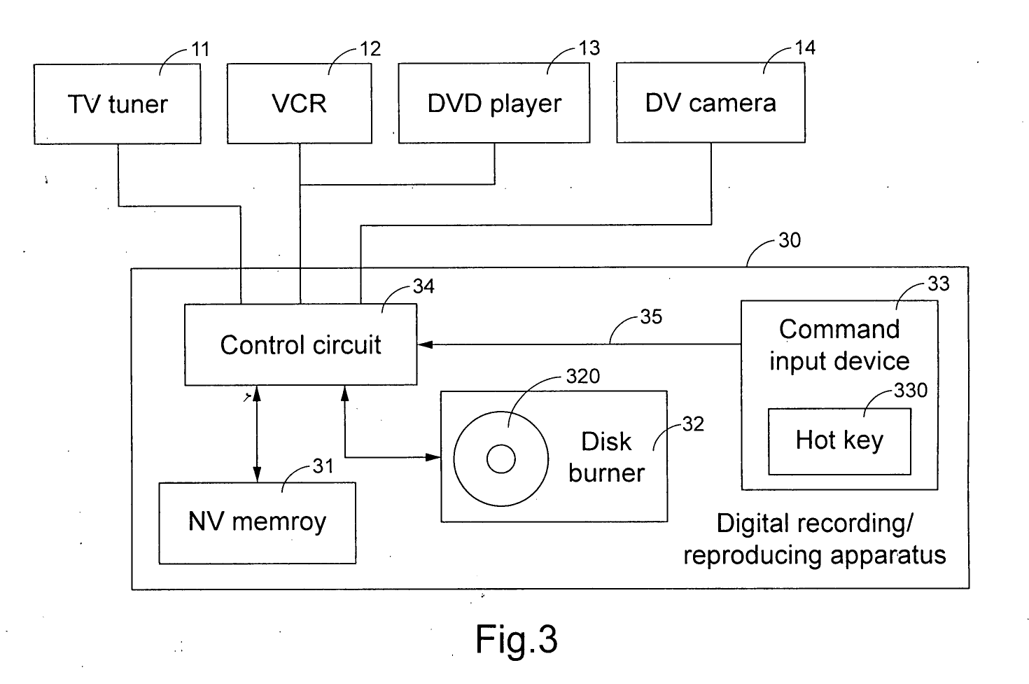

Please refer to FIG. 3. An embodiment of a digital recording/reproducing apparatus according to the present invention includes a non-volatile memory 31, a disc burner 32, a command input device 33 and a control circuit 34 accommodated in a housing 30. The command input device 33 includes a hot key 330 disposed on a surface of the housing 34 accessible by the user and electrically connected to the control circuit 34 via a cable 35. For example, the command input device 33 can be a control panel of the digital recording/reproducing apparatus and the hot key 330 is one of the buttons on the control panel 33. When the digital recording/reproducing apparatus is initialized, the disc burner 32 is preset to be operated at a low rotating speed in order not to emit annoying noise. Then, if the user would like to complete the recording operation quickly, he can actuate the hot key 330 on the housing 30 to accelerate the rotating speed of the disc burner 32, for example from 2× Constant Angular Velocity (CAV) to 8× CAV, where the “1×” of speed can refer to about 150 k Bytes of data transferred per second.

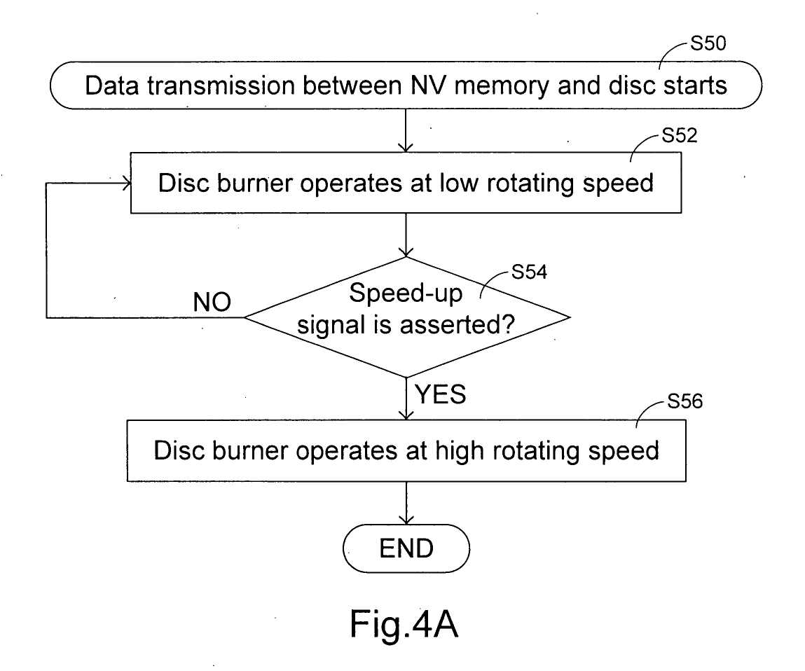

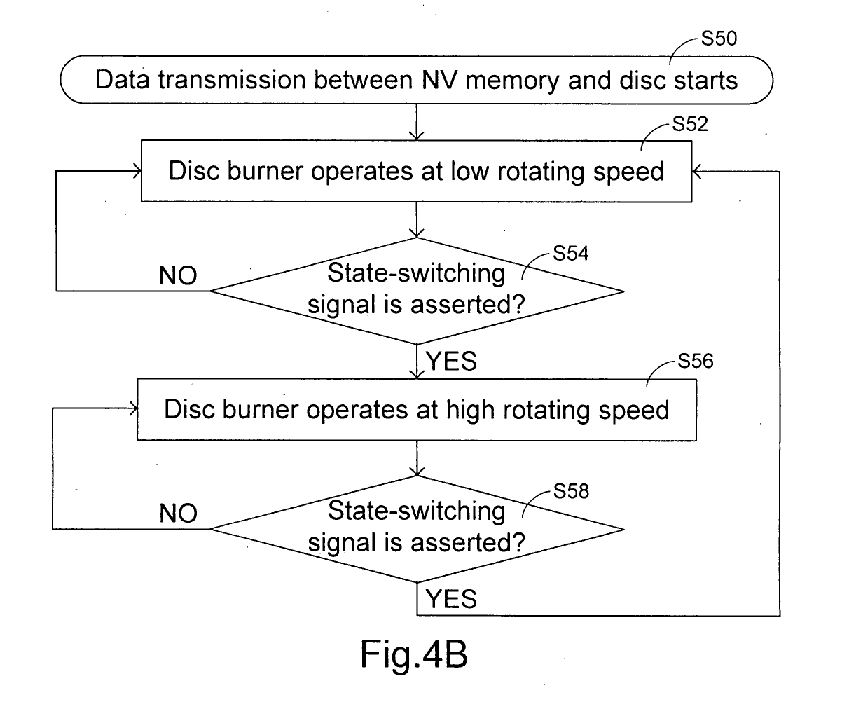

With reference to the flowchart of FIG. 4A, for copying data between the non-volatile memory 31 and a disc 320 loaded in the disc burner 32 (S50), either memory-to-disc or disc-to-memory copy, the disc burner 32 is first operated at a preset speed, e.g. 2× CAV (S52). During the data transmission, once the command input device 33 is triggered to assert a speed-up signal to the control circuit 34 via the cable 35 (S54), the control circuit 34 will raise the rotating speed of the disc burner 32 to for example 8× CAV (S56). Accordingly, the recording operation can be executed at a high speed and completed as quickly as possible.

In the above embodiment, the disc burner 32 is made sure to operate at a high speed whenever the hot key 330 is triggered. Alternatively, the hot key 330 can be designed to toggle upon triggering. In other words, the rotating speed of the disc burner 32 can change alternately low-to-high (S52, S54, S56) and high-to-low (S56, S58, S52) in response to a state-switching signal asserted when the hot key 330 is triggered, as illustrated in the flowchart of FIG. 4B.

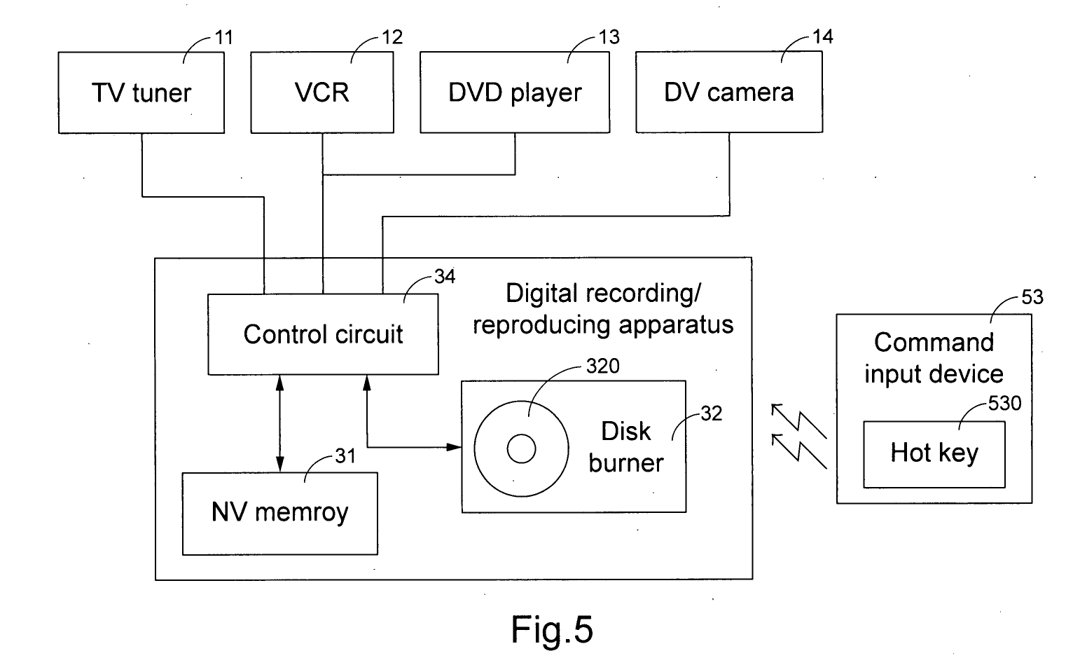

In another embodiment, the command input device is separated from the main body of the digital recording/reproducing apparatus and communicates with the control circuit wirelessly. For example, as shown in FIG. 5, the command input device 53 is a remote controller and the hot key 530 is a designated button on the remote controller 53. Whenever the hot key 530 is pushed, a state-switching signal (or speed-up signal) is asserted to accomplish the rotating speed change of the disc burner 32.

The digital recording/reproducing apparatus, for example, can be a DVD player. In this case, the non-volatile memory 31 used in the above embodiments, for example, can be implemented with a hard disc or a flash memory module. The disc 320, when used to record data from the non-volatile memory 31, should be a recordable disc, and the type of the disc 320, for example, can be CD-R, CD-RW, DVD-R or DVD-RW.

By using a command input device to impart selectable rotating speeds to the digital recording/reproducing apparatus, the recording operation can be performed in a flexible manner. With a low rotating speed, noise can be exempted from. On the other hand, with a high rotating speed, the recording time can be reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An operational speed control method of a digital recording/reproducing apparatus, said digital recording/reproducing apparatus having a non-volatile memory, a disc burner and a command input device, said method comprising steps of:
asserting a state-switching signal in response to a triggering operation of said command input device; and
changing an operational speed of said disc burner for copying data between said non-volatile memory and a disc in response to said state-switching signal.

2. The operational speed control method according to claim 1 wherein said triggering operation of said command input device is implemented by pushing a hot key on said command input device.

3. The operational speed control method according to claim 1 wherein said operational speed of said disc burner is changed between a high rotating speed and a low rotating speed in response to said state-switching signal.

4. The operational speed control method according to claim 1 wherein said state-switching signal is transmitted from said command input device to a control circuit for controlling said disc burner via a cable.

5. The operational speed control method according to claim 1 wherein said state-switching signal is transmitted wirelessly from said command input device to a control circuit for controlling said disc burner.

6. The operational speed control method according to claim 1 wherein said disc is a recordable disc if said data is previously stored in said non-volatile memory and is to be written into said disc.

7. The operational speed control method according to claim 1 further comprising a step of presetting an initial operational speed of said disc burner at a first rotating speed, wherein said first rotating speed is increased to a second rotating speed in response to said triggering operation of said command input device.

8. A rotating speed control method of a digital recording/reproducing apparatus, said digital recording/reproducing apparatus having a non-volatile memory, a disc burner and a command input device, said method comprising steps of:
asserting a speed-up signal in response to a triggering operation of said command input device; and
accelerating a rotating speed of said disc burner for copying data between said non-volatile memory and a disc from a first rotating speed to a second rotating speed in response to said speed-up signal.

9. The rotating speed control method according to claim 8 further comprising a step of presetting an initial rotating speed of said disc burner at said first rotating speed when said digital recording/reproducing apparatus is initialized.

10. The rotating speed control method according to claim 8 wherein said speed-up signal is transmitted from said command input device to a control circuit for controlling said disc burner via a cable.

11. The rotating speed control method according to claim 8 wherein said speed-up signal is transmitted wirelessly from said command input device to a control circuit for controlling said disc burner.

12. The rotating speed control method according to claim 8 wherein said triggering operation of said command input device is implemented by pushing a hot key on said command input device.

13. A digital recording/reproducing apparatus, comprising:
a control circuit;
a non-volatile memory;
a disc burner electrically connected to said control circuit and selectively operated at a first rotating speed or a second rotating speed under the control of said control circuit for copying data between said non-volatile memory and a disc at different operational speeds; and
a command input device coupled to said control circuit and changing an operational speed of said disc burner between said first and second rotating speeds in response to a user' operation.

14. The digital recording/reproducing apparatus according to claim 13 wherein said command input device includes a hot key and said user's operation is the actuation of said hot key.

15. The digital recording/reproducing apparatus according to claim 13 wherein said command input device is a control panel electrically connected to said control circuit via a cable.

16. The digital recording/reproducing apparatus according to claim 13 wherein said command input device is a remote controller in wireless communication with said control circuit.
